(19) United States
(12) Patent Application Publication
(10) Pub. No.: US 2024/0212167 A1
(43) Pub. Date: Jun. 27, 2024

(54) DATA AUGMENTATION APPARATUS AND METHOD FOR ACTION RECOGNITION THROUGH SELF-SUPERVISED LEARNING BASED ON OBJECT

(71) Applicant: Gwangju Institute of Science and Technology, Gwangju (KR)

(72) Inventors: Dae Young HAN, Gwangju (KR); Moon Gu JEON, Gwangju (KR)

(73) Assignee: Gwangju Institute of Science and Technology, Gwangju (KR)

(21) Appl. No.: 18/386,265

(22) Filed: Nov. 2, 2023

(30) Foreign Application Priority Data
Dec. 26, 2022 (KR) 10-2022-0184018

(51) Int. Cl. G06T 7/20; G06T 7/50; G06T 7/60; G06T 7/70; G06V 10/44

(52) U.S. Cl. CPC G06T 7/20; G06T 7/50; G06T 7/60; G06T 7/70; G06V 10/44

(57) ABSTRACT

The present invention relates to a data augmentation apparatus for action recognition through self-supervised learning based on objects, including: an image input unit for inputting image information; an information extraction unit for extracting a feature vector with object information from motion data of the inputted image information; and a motion information synthesis unit for synthesizing motion data taking a different action and the feature vector with the object information to generate new motion data.

### BACKGROUND OF THE INVENTION

### Cross Reference to Related Application of the Invention

The present application claims the benefit of Korean Patent Application No. 10-2022-0184018 filed in the Korean Intellectual Property Office on 12/26, 2022, the entire contents of which are incorporated herein by reference.

### FIELD OF THE INVENTION

The present invention relates to a data augmentation technique for improving the performance of action recognition models, more specifically to a data augmentation apparatus for action recognition using an object information-based skeleton generation model performing self-supervised learning.

### BACKGROUND OF THE RELATED ART

Skeleton-based action recognition, which abstracts a body of a person on an image to two or three-dimensional skeleton and recognizes his or her actions, advantageously has smaller data size than original image and explicitly treats the relationships among skeleton joints. However, the skeleton-based action recognition disadvantageously needs the pre-processing of estimating the joints of the body on the image. To collect skeleton data, further, body tracking equipment and an imaging place are required, and a large number of people for capturing images in various conditions are needed. If the skeleton data are not sufficiently provided, a degree of accuracy of a recognition model for learning may be deteriorated, and the generality for different types of users may be lowered. Accordingly, studies of augmentation for imaging subjects as well as classes and the number of images have to be needed.

The background of the related art of the invention is disclosed in Korean Patent No. 10-2277530.

### SUMMARY OF THE INVENTION

Accordingly, the present invention has been made in view of the above-mentioned problems occurring in the related art, and it is an object of the present invention to provide a data augmentation apparatus and method for action recognition through self-supervised learning based on objects.

To accomplish the above-mentioned objects, according to one aspect of the present invention, there is provided a data augmentation apparatus for action recognition through self-supervised learning based on objects, including: an image input unit for inputting image information; an information extraction unit for extracting a feature vector with object information from motion data of the inputted image information; and a motion information synthesis unit for synthesizing motion data taking a different action and the feature vector with the object information to generate new motion data.

To accomplish the above-mentioned objects, according to another aspect of the present invention, there is provided a computer program executing a data augmentation method for action recognition through self-supervised learning based on objects.

To accomplish the above-mentioned objects, according to yet another aspect of the present invention, there is provided a data augmentation method for action recognition through self-supervised learning based on objects, the data augmentation method including the steps of: inputting image information; extracting a feature vector with object information from motion data of the inputted image information; and synthesizing motion data taking a different action and the feature vector with the object information to generate new motion data.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing a data augmentation apparatus for action recognition through self-supervised learning based on objects according to the present invention;

FIG. 2 is a flowchart showing an operating process of the data augmentation apparatus for action recognition through self-supervised learning based on objects according to the present invention;

FIGS. 3 to 4 are flowcharts showing learning processes of the data augmentation apparatus for action recognition through self-supervised learning based on objects according to the present invention;

FIG. 5 shows a data generation process of the data augmentation apparatus for action recognition according to the present invention; and

FIG. 6 is a flowchart showing a data augmentation method for action recognition through self-supervised learning based on objects according to the present invention.

### DETAILED DESCRIPTION OF THE PREFERRED EMBODIMENTS

Hereinafter, embodiments of the present invention will be described in detail with reference to the attached drawings. Before the present invention is disclosed and described, it is to be understood that the disclosed embodiments are merely exemplary of the invention, which can be embodied in various forms. If it is determined that the detailed explanation on the well-known technology related to the present invention makes the scope of the present invention not clear, the explanation will be avoided for the brevity of the description. As used in the present disclosure and the appended claims, it shall be understood that the singular forms “a,” “an” and “the” are intended to include the plural forms “one or more” as well, unless the context clearly indicates otherwise.

In the description, when it is said that one element is described as being “connected” or “coupled” to the other element, one element may be directly connected or coupled to the other element, but it should be understood that another element may be present between the two elements. In the description, further, when it is said that one portion is described as “includes” any component, one element further may include other components unless no specific description is suggested.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

Hereinafter, the present invention will be described in detail with reference to the attached drawings. However, it is to be understood that the disclosed embodiments are merely exemplary of the invention, which can be embodied in various forms. In the drawings, portions having no relation with the description of the present invention are omitted so that the present invention can be obviously understood, and in the description, the corresponding parts in the embodiments of the present invention are indicated by corresponding reference numerals.

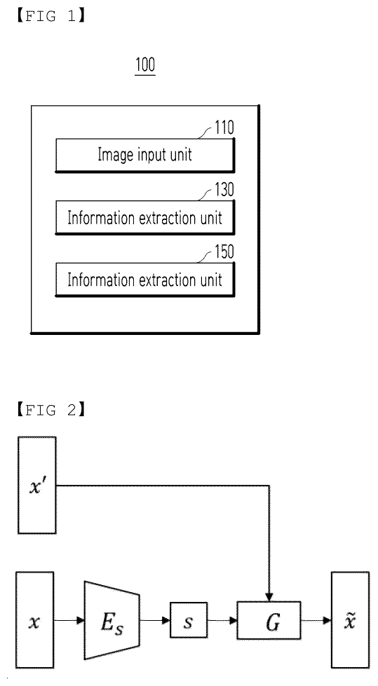

FIG. 1 is a block diagram showing a data augmentation apparatus for action recognition through self-supervised learning based on objects according to the present invention.

Referring to FIG. 1, a data augmentation apparatus for action recognition through self-supervised learning based on objects according to the present invention includes an image input unit 110, an information extraction unit 130, and a motion information synthesis unit 150.

The image input unit 110 inputs image information. The image input unit 110 inputs the image information, as the form of a camera, but it may not be limited thereto.

The information extraction unit 130 extracts object information from skeleton data of the image information inputted. For example, the information extraction unit 130 extracts a feature vector s with the object information from the skeleton data x. The information extraction unit 130 performs the sampling for two different sets of skeleton data, extracts object information feature vectors from the two sets of skeleton data, and thus learns to allow a distance between the feature vectors to be distant from each other. Further, the information extraction unit 130 applies simple deformation such as rotation or parallel movement to one of the sampled skeleton data to make different data having the same object information as the deformed skeleton data. In this case, the information extraction unit 130 learns to allow a distance between the feature vector extracted from the data produced through the deformation and the feature vector before the deformation to be close to each other. Through such self-supervised learning, the information extraction unit 130 extracts the feature vector with the inherent object information from the skeleton data.

The motion information synthesis unit 150 performs sampling for the skeleton data taking a different action from the skeleton data, inputs the sampled skeleton data, together with the feature vector extracted through the information extraction unit 130, and synthesizes new motion data with the corresponding object information. In specific, the motion information synthesis unit 150 generates the new motion data with the same object information such as body shape, body height, and posture as the sampled skeleton data through the information extraction unit 130 and executing the same action as the skeleton data sampled therein. For example, the motion information synthesis unit 150 receives the skeleton data x′ taking the different action from the skeleton data x and the object information feature vector s and thus synthesizes new motion data taking the action of the skeleton data x′ of the feacture vector s.

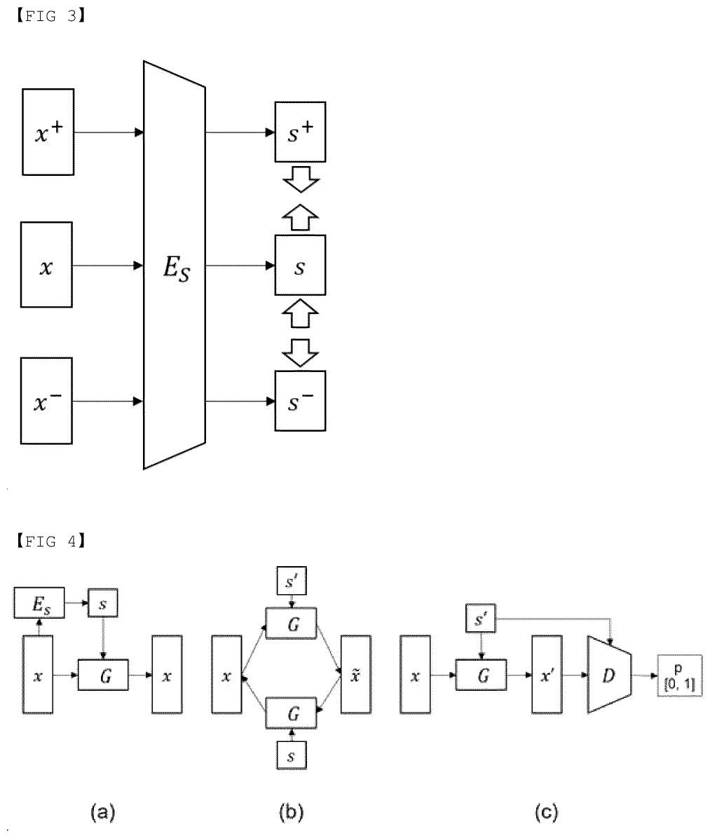

FIG. 2 is a flowchart showing an operating process of the data augmentation apparatus for action recognition through self-supervised learning based on objects according to the present invention.

Referring to FIG. 2, the data augmentation apparatus for action recognition through self-supervised learning based on objects according to the present invention inserts the skeleton data x using a style encoder Eₛ and thus extracts the feacture vector s with the object information. Further, the data augmentation apparatus for action recognition according to the present invention receives another skeleton data and the extracted object information feature vector to synthesize the new motion data \tilde{x} taking the action of the skeleton data x′ of the the facture vector s using a generator G.

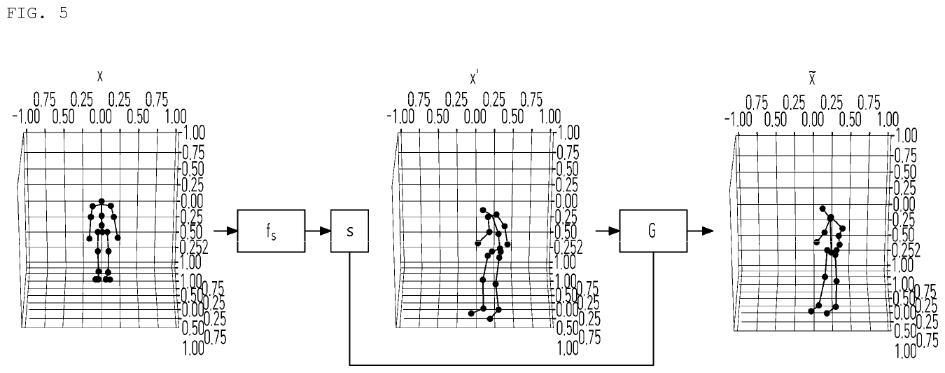

FIGS. 3 to 4C are flowcharts showing learning processes of the data augmentation apparatus for action recognition through self-supervised learning based on objects according to the present invention.

Referring first to FIG. 3, the data augmentation apparatus for action recognition through self-supervised learning based on objects according to the present invention learns the style encoder Eₛ through the self-supervised learning. The data augmentation apparatus for action recognition according to the present invention performs the sampling for the skeleton data x from a publicly available large-scale dataset. Further, the data augmentation apparatus for action recognition according to the present invention performs the sampling for another skeleton data x⁻. In this case, the data augmentation apparatus for action recognition according to the present invention applies given deformation such as rotation or parallel movement to the skeleton data x to obtain another skeleton data x⁺. Through the three samples, the data augmentation apparatus for action recognition according to the present invention learns to allow a distance between Eₛ (x) and Eₛ(x⁺) to be close to each other and to allow a distance between Eₛ(x) and Eₛ(x⁻) to be distant from each other. As a result, the data augmentation apparatus for action recognition according to the present invention allows the style encoder Eₛ to receive the skeleton data and thus output the feature vector $ with the inherent object information.

Referring to FIG. 4A, the data augmentation apparatus for action recognition according to the present invention extracts the object information feature vector s from the skeleton data x using the style encoder Eₛ. In this case, the data augmentation apparatus for action recognition according to the present invention learns to generate the original skeleton data x from the skeleton data x and the object information feature vector s using the generator G.

Referring to FIG. 4B, the data augmentation apparatus for action recognition according to the present invention extracts object information feature vectors s and s′ from the skeleton data x and another skeleton data x′ using the style encoder Eₛ. In this case, the data augmentation apparatus for action recognition according to the present invention learns to generate new skeleton data \tilde{x} from the skeleton data x and the object information feature vector s′ using the generator G, input the new skeleton data \tilde{x} and the object information feature vector s to the generator G, and re-generate the skeleton data x.

Referring to FIG. 4C, the data augmentation apparatus for action recognition according to the present invention allows the generator G to perform adversarial learning, together with a discriminator D, to improve the performance of the generator G. In this case, the discriminator D learns to accurately determine that the skeleton data x′ generated from the generator G is not real, and the generator G learns to generate the skeleton data looking like more real so that the discriminator D determines the skeleton data x′ is real. As such adversarial learning is repeatedly performed, the generator G of the data augmentation apparatus for action recognition according to the present invention can be improved in performance.

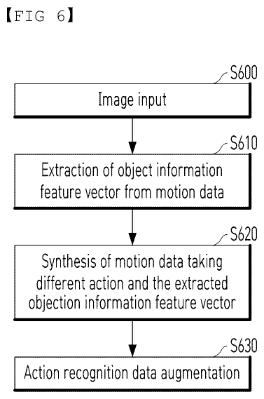

FIG. 5 shows a data generation process of the data augmentation apparatus for action recognition according to the present invention.

Referring to FIG. 5, the data augmentation apparatus for action recognition according to the present invention inputs the object information feature vector s extracted from the skeleton data x through the style encoder Eₛ and another skeleton data x′ to the generator G and thus generates the new skeleton data x taking the same action as the skeleton data x′ but having the same object information such as body height, body shape, and posture as the skeleton data x. For example, the data augmentation apparatus for action recognition according to the present invention extracts the feature vector with the information such as body height, body shape, and posture from arbitrary data of a 150 cm woman in her 20s and inputs the extracted feature vector to the generator G, together with arbitrary motion data of a 175 cm man in his 50s who moves a load, so that the motion data of a 150 cm woman in her 20s who moves a load, which do not exist in the existing data set, is generated. Through such a method, even in a condition where the motion data of a 150 cm woman in her 20s who moves a load does not exist, the data augmentation apparatus for action recognition according to the present invention generates about 1000 sets of motion data of a 150 cm woman in her 20s who moves a load using the data of 1000 people in arbitrary age groups who have arbitrary body shapes.

FIG. 6 is a flowchart showing a data augmentation method for action recognition through self-supervised learning based on objects according to the present invention.

Referring to FIG. 6, the data augmentation apparatus for action recognition according to the present invention receives image information at step S600. At the step S600, the data augmentation apparatus for action recognition according to the present invention receives video and image information to the form of a camera, but it may not be limited thereto.

At step S610, the data augmentation apparatus for action recognition according to the present invention extracts a feature vector with the object information from the object motion data obtained from the received image at the step S600. For example, the data augmentation apparatus for action recognition according to the present invention extracts the feature vector $ with the object information from the motion data & through the style encoder Eₛ.

At step S620, the data augmentation apparatus for action recognition according to the present invention synthesizes the object information extracted at the step S610 and arbitrary motion data taking a different action from the object information. At the step S620, in specific, the data augmentation apparatus for action recognition according to the present invention synthesizes the motion data having the features such as body height, body shape, and posture of the person on the image received at the step S600 and taking a different action from the action taken by the person. For example, the data augmentation apparatus for action recognition according to the present invention receives the motion data x′ taking the different action and the object information § to thus synthesize the new motion data x taking the action of the motion data x′ of the object information s.

At step S630, the data augmentation apparatus for action recognition according to the present invention includes the synthesized new motion data in a learning data set to perform data augmentation. For example, the data augmentation apparatus for action recognition according to the present invention repeats the data generation process of the step S620 to perform augmentation of data of relatively minor body shape, age group, and sex, thereby improving the performance of various action recognition models.

As described above, the data augmentation apparatus for action recognition through self-supervised learning based on objects according to the present invention increases the number of imaging subjects through the generative model making new skeleton data of an imaging subject, deforms the collected data correspondingly to a group whose data collection is impossible, and performs the augmentation of the data. Further, the data augmentation apparatus for action recognition according to the present invention performs the data deformation in consideration of various features such as body shape, body height, and posture and augments various imaging subject data similar to real data, thereby enhancing the performance of the action recognition models.

The effectiveness of the invention is not limited as mentioned above, and it should be understood to those skilled in the art that the effectiveness of the invention may include another effectiveness as not mentioned above from the detailed description or claims of the present invention.

In the above, the embodiments of the present invention where all components are coupled to a single apparatus or coupledly operate have been explained, but the present invention may not be limited necessarily to the embodiments. In specific, all components may be selectively coupled to one or more apparatuses and thus operate.

The operations are indicated in the drawings in specific steps, but it should be understood that the illustrated specific steps, the sequential steps, or all the specific steps are not necessarily carried out so as to accomplish desired results. In arbitrary environments, multitasking and parallel processing are more advantageous. Furthermore, it should be understood that the classification of the various components is not needed for all the embodiments of the present invention and that the described components are integrated as a single software product or packaged as a plurality of software products.

As mentioned above, the preferred embodiment of the present invention has been disclosed in the specification and drawings. In the description of the present invention, special terms are used not to limit the present invention and the scope of the present invention as defined in claims, but just to explain the present invention. Therefore, persons skilled in the relevant art can appreciate that many modifications and variations are possible in light of the above teachings. It is therefore intended that the scope of the invention be limited not by this detailed description, but rather by the claims appended hereto.

What is claimed is:

1. A data augmentation apparatus for action recognition through self-supervised learning based on objects, comprising:
an image input unit for inputting image information;
an information extraction unit for extracting a feature vector with object information from motion data of the inputted image information; and
a motion information synthesis unit for synthesizing motion data taking a different action and the feature vector with the object information to generate new motion data.

2. The data augmentation apparatus according to claim 1, wherein the information extraction unit obtains the motion data from the inputted image information and extracts the feature vector with the object information of the motion data from the motion data.

3. The data augmentation apparatus according to claim 1, wherein the motion information synthesis unit synthesizes the motion data taking the different action from the motion data and the feature vector with the object information to generate the new motion data.

4. The data augmentation apparatus according to claim 3, wherein the motion information synthesis unit synthesizes the new motion data having at least one of the object information of the body shape, body height, and posture of the motion data received initially and taking the different action from the motion data received initially.

5. A data augmentation method for action recognition through self-supervised learning based on objects, the data augmentation method comprising the steps of:
inputting image information;
extracting a feature vector with object information from motion data of the inputted image information; and
synthesizing motion data taking a different action and the feature vector with the object information to generate new motion data.

6. The data augmentation method according to claim 5, wherein the step of extracting a feature vector with object information from motion data of the inputted image information is performed to obtain the motion data from the inputted image information and thus extract the feature vector with the object information of the motion data from the motion data.

7. The data augmentation method according to claim 5, wherein the step of synthesizing motion data taking a different action and the object information to generate new motion data is performed to synthesize the motion data taking the different action from the motion data and the feature vector with the object information to generate the new motion data.

8. The data augmentation method according to claim 7, wherein the step of synthesizing motion data taking a different action and the object information to generate new motion data is performed to synthesize the new motion data having at least one of the object information of the body shape, body height, and posture of the motion data received initially and taking the different action from the motion data received initially.

9. A computer program executing the data augmentation method for action recognition through self-supervised learning based on objects according to claim 5 and recorded on a computer-readable recording medium.
